(19) United States
(12) Patent Application Publication
(10) Pub. No.: US 2026/0065017 A1
(43) Pub. Date: Mar. 5, 2026

(54) UNIFYING A QUOTA REPRESENTATION AND MANAGEMENT FOR HETEROGENOUS RESOURCES

(71) Applicant: INTERNATIONAL BUSINESS MACHINES CORPORATION, Armonk, NY (US)

(72) Inventors: Abhishek Malvankar, White Plains, NY (US); Olivier Luc Jean Tardieu, White Plains, NY (US); Alaa S. Youssef, Valhalla, NY (US); Asser Nasreldin Tantawi, Somers, NY (US); Pedro David Bello-Maldonado, New York, NY (US)

(21) Appl. No.: 18/818,294

(22) Filed: Aug. 28, 2024

(51) Int. Cl. G06N 3/045

(52) U.S. Cl. CPC G06N 3/045

(57) ABSTRACT

Embodiments receive a user request with resource specifications from an external application, extract select resource management sections from the received user request, classifying, the extracted select resource management sections using a first machine learning (ML) model which is trained using a historical dataset, map the classified extracted select resource management sections to at least one integer value, deduct the at least one integer value from a quota management tree to determine configuration specifications, and execute accelerators using the configuration specifications from artificial intelligence (AI) workloads.

### BACKGROUND

Aspects of the present invention relate generally to unifying a quota representation and management for heterogenous resources.

Artificial intelligence (AI) workloads use accelerators, such as graphics processing units (GPUs) and field programmable gate arrays (FGPAs). These accelerators have resources in multiple dimensions, such as an accelerator memory, an accelerator core, etc.

### SUMMARY

In a first aspect of the invention, there is a computer-implemented method including: receiving, by a processor set, a user request with resource specifications from an external application; extracting, by the processor set, select resource management sections from the received user request; classifying, by the processor set, the extracted select resource management sections using a first machine learning (ML) model which is trained using a historical dataset; mapping, by the processor set, the classified extracted select resource management sections to at least one integer value; deducting, by the processor set, the at least one integer value from a quota management tree to determine configuration specifications; and executing, by the processor set, the accelerators using the configuration specifications for artificial intelligence (AI) workloads.

In another aspect of the invention, there is a computer program product including one or more computer readable storage media having program instructions collectively stored on the one or more computer readable storage media. The program instructions are executable to: receive a user request with resource specifications from an external application; extract select resource management sections from the received user request; classify the extracted select resource management sections using a first machine learning (ML) model which is trained using a historical classification dataset; map the classified extracted select resource management sections to at least one integer value by using a second ML model which is trained using a historical integer value dataset; deduct the at least one integer value from a quota management tree to determine configuration specifications; and executing, by the processor set, the accelerators using the configuration specifications for artificial intelligence (AI) workloads.

In another aspect of the invention, there is a system including a processor set, one or more computer readable storage media, and program instructions collectively stored on the one or more computer readable storage media. The program instructions are executable to: receive a user request with resource specifications from an external application; extract select resource management sections from the received user request; classify the extracted select resource management sections using a first machine learning (ML) model which is trained using a historical classification dataset; map the classified extracted select resource management sections to at least one integer value by using a second ML model which is trained using a historical integer value dataset; deduct the at least one integer value from a quota management tree to determine configuration specifications; and executing, by the processor set, the accelerators using the configuration specifications for artificial intelligence (AI) workloads. The first ML model includes a decision tree model which utilizes a decision tree algorithm to classify the extracted select resource management sections.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows an example of a historical dataset in accordance with aspects of the present invention.

FIG. 4 shows an example of a quota management tree in accordance with aspects of the present invention.

FIG. 5 shows a flowchart of an exemplary method in accordance with aspects of the present invention.

FIG. 6 shows a flowchart of an exemplary method in accordance with aspects of the present invention.

FIG. 7 shows a flowchart of an exemplary method in accordance with aspects of the present invention.

### DETAILED DESCRIPTION

Aspects of the present invention relate generally to unifying a quota representation and management for heterogenous resources. Embodiments of the present invention provide a system, a computer program product, and computer-implemented method for unifying a quota representation and management for heterogenous resources in a cloud. Embodiments of the present invention simplify management of quotas for administrators. In particular, aspects of the present invention provide a system, a computer program product, and computer-implemented method to provide an instantaneous scale for bringing different accelerated resources from vendors and/or cloud providers. Embodiments of the present invention utilize an optimized machine learning (ML) algorithm to simplify quota deduction for accelerators based on resource requirements specified by the user.

Embodiments of the present invention also provide a configuration value for accelerators consumed by a cluster. Embodiments of the present invention provide an ML model prediction to subtract quotas from computing resources. Embodiments of the present invention utilize quota management to work transparently with any accelerators (e.g., artificial intelligence unit (AIU)). Embodiments of the present invention also utilize quota management to consider priority when deducting a quota from a resource management. Aspects of the present invention also maximize accelerator memory resources and accelerator core resources for artificial intelligence (AI) workloads. In particular, AI workloads typically use accelerators such as graphical processing units (GPUs), field programmable gate arrays (FPGAs), etc., which manage multiple resource dimensions and multiple user requirements.

In a first aspect of the invention, there is a computer-implemented method including: receiving, by a processor set, a user request with resource specifications from an external application; extracting, by the processor set, select resource management sections from the received user request; classifying, by the processor set, the extracted select resource management sections using a first machine learning (ML) model which is trained using a historical dataset; mapping, by the processor set, the classified extracted select resource management sections to at least one integer value; deducting, by the processor set, the at least one integer value from a quota management tree to determine configuration specifications; and executing, by the processor set, the accelerators using the configuration specifications for artificial intelligence (AI) workloads. In particular, embodiments may execute accelerators for improving AI workloads by generating configuration specifications which correspond to a user request with resource specifications.

The computer-implemented method may include the resource management sections comprise a graphical processing unit (GPU) type, a central processing unit (CPU) memory requirement, and a random access memory (RAM) requirement. In particular, embodiments may execute accelerators for improving AI workloads which correspond with a graphical processing unit (GPU) type, a CPU memory requirement, and a random access memory (RAM) requirement.

The computer-implemented method may include the classified extracted select resource management sections comprises a class of a plurality of classes. In particular, embodiments may perform classification of the extracted select resource management sections using a particular class for improving AI workloads.

The computer-implemented method may include the plurality of classes including a high class, a medium class, and a low class. In particular, embodiments may perform classification of the extracted select resource management sections using a particular class of a high class, a medium class, and a low class for improving AI workloads.

The computer-implemented method may include the at least one integer value corresponding with the class of the plurality of classes. In particular, embodiments may perform mapping of the at least one integer value to correspond with a particular class for improving AI workloads.

The computer-implemented method may include the mapping the extracted select resource management to the at least one integer value being performed by using a database lookup operation of a database. In particular, embodiments may perform mapping of the at least one integer value using a database lookup operation of a database for improving AI workloads.

The computer-implemented method may include the mapping the extracted select resource management to the at least one integer value being performed by utilizing a second ML model which is trained using a historical integer value dataset. In particular, embodiments may perform mapping of the at least one integer value by utilizing a machine learning model which is trained using a historical integer value dataset for improving AI workloads.

The computer-implemented method may include the first ML model including a decision tree model which utilizes a decision tree algorithm to classify the extracted select resource management sections. In particular, embodiments may have an ML model which includes a decision tree which utilizes a decision tree algorithm to classify the extracted select resource management sections for improving AI workloads.

The computer-implemented method may include the first ML model including a neural network model to classify the extracted select resource management sections. In particular, embodiments may have an ML model which includes a neural network model to classify the extracted select resource management sections for improving AI workloads.

The computer-implemented method may include the accelerators including at least one graphical processing unit (GPU). In particular, embodiments may have accelerators which include at least one GPU for improving AI workloads.

The computer-implemented method may include the accelerators including at least one field programmable gate array (FPGA). In particular, embodiments may have accelerators which include at least one FPGA for improving AI workloads.

In another aspect of the invention, there is a computer program product including one or more computer readable storage media having program instructions collectively stored on the one or more computer readable storage media. The program instructions are executable to: receive a user request with resource specifications from an external application; extract select resource management sections from the received user request; classify the extracted select resource management sections using a first machine learning (ML) model which is trained using a historical classification dataset; map the classified extracted select resource management sections to at least one integer value by using a second ML model which is trained using a historical integer value dataset; deduct the at least one integer value from a quota management tree to determine configuration specifications; and executing, by the processor set, the accelerators using the configuration specifications for artificial intelligence (AI) workloads. In particular, embodiments may execute accelerators for improving AI workloads which correspond to a user request with resource specifications.

The computer program product may include the resource management sections comprise a graphical processing unit (GPU) type, a central processing unit (CPU) memory requirement, and a random access memory (RAM) requirement. In particular, embodiments may execute accelerators for improving AI workloads which correspond with a graphical processing unit (GPU) type, a CPU memory requirement, and a random access memory (RAM) requirement.

The computer program product may include the classified extracted select resource management sections comprises a class of a plurality of classes. In particular, embodiments may perform classification of the extracted select resource management sections using a particular class for improving AI workloads.

The computer program product may include the plurality of classes including a high class, a medium class, and a low class. In particular, embodiments may perform classification of the extracted select resource management sections using a particular class of a high class, a medium class, and a low class for improving AI workloads.

The computer program product may include the at least one integer value corresponding with the class of the plurality of classes. In particular, embodiments may perform mapping of the at least one integer value to correspond with a particular class for improving AI workloads.

The computer program product may include the first ML model including a decision tree model which utilizes a decision tree algorithm to classify the extracted select resource management sections. In particular, embodiments may have an ML model which includes a decision tree which utilizes a decision tree algorithm to classify the extracted select resource management sections for improving AI workloads.

The computer program product may include the first ML model including a neural network model to classify the extracted select resource management sections. In particular, embodiments may have an ML model which includes a neural network model to classify the extracted select resource management sections for improving AI workloads.

The computer program product may include the accelerators including at least one graphical processing unit (GPU). In particular, embodiments may have accelerators which include at least one GPU for improving AI workloads.

In another aspect of the invention, there is a system including a processor set, one or more computer readable storage media, and program instructions collectively stored on the one or more computer readable storage media. The program instructions are executable to: receive a user request with resource specifications from an external application; extract select resource management sections from the received user request; classify the extracted select resource management sections using a first machine learning (ML) model which is trained using a historical classification dataset; map the classified extracted select resource management sections to at least one integer value by using a second ML model which is trained using a historical integer value dataset; deduct the at least one integer value from a quota management tree to determine configuration specifications; and executing, by the processor set, the accelerators using the configuration specifications for artificial intelligence (AI) workloads. The ML model includes a decision tree model which utilizes a decision tree algorithm to classify the extracted select resource management sections. In particular, embodiments may execute accelerators for improving AI workloads which correspond to a user request with resource specifications.

In an exemplary use case, embodiments of the present invention may be used in or with a quota representation and management server to unify a quota representation and management for heterogenous resources to improve AI workloads. In this use case, the quota representation and management server utilizes machine learning (ML) to classify aspects of a user request with resource specifications to derive configuration specifications using deduction of an integer value from a quota management tree. In various examples, the quota representation and management server improves execution of AI workloads using different accelerators that are configured using the derived configuration specifications.

Embodiments of the present invention provide a computer-implemented method, a system, and a computer program product for unifying a quota representation and management across any hardware accelerator used in a cloud mapping to deduct a quota. In contrast, conventional systems merely share and borrow available cluster resources (i.e., dynamic resource allocation) for user quotas. Further, conventional systems manually configure each system quota by system admins for a target subsystem. Also, although conventional systems perform a dynamic resource allocation to attempt to configure accelerators in various ways, the dynamic resource allocation approach in conventional systems is not able to adapt to multiple resource dimensions (i.e., multi-constraint quota management) or multiple user requests (i.e., multi-condition quota management). Accordingly, embodiments of the present invention provide a quota representation and management to take into account memory and tensor cores across different accelerators. Aspects of the present invention assign integer values to different accelerators independently of other resource quotas. Embodiments of the present invention also update each node in a cluster in response to new accelerators being added and allocated within the cluster and substantially reduce an overall complexity by providing only a minimum level of access or permissions to perform specific tasks and functions within applications.

Embodiments of the present invention include a system, method, and computer program product for utilizing machine learning to perform quota deduction for accelerators based on resource requirements specified by a user. Accordingly, implementations of the present invention provide an improvement (i.e., technical solution) to a problem arising in the technical field of performing resource and quota management with multi-constraint and multi-condition variables. In particular, embodiments of the present invention utilize a machine learning (ML) model to improve classification of the resource requirements specified by the user to improve execution of accelerators, such as at least one of a GPU and a FPGA.

Implementations of the present invention are necessarily rooted in computer technology. For example, the step of classifying the extracted select resource management sections using a machine learning (ML) model which is trained using a historical dataset cannot be performed in the human mind (or with pen and paper). Training and building the ML model is, by definition, performed by a computer and cannot be performed in the human mind (or with a pen and paper) due to the complexity and the massive amounts of calculations involved. For example, training and building the ML model in embodiments of the present invention may utilize machine learning to build and train the ML model using historical classification data to improve accuracy of classification and also improve execution of accelerators due to the improved accuracy of the classification. In particular, training and building the ML model includes processing a large amount of historical classification data and modeling of parameters to train the ML model in a short period of time so that the ML model generates and outputs classifications of resource requirements in real time (or near real time). In other words, the ML model is trained using a large amount of previously captured historical classification data and other parameters such that the ML model is configured to output a classification of the resource requirements specified by the user in real-time. Given the scale and complexity of processing historical classification data and modeling of parameters, it is simply not possible for the human mind, or for a person using a pen and paper, to perform the number of calculations involved in training and/or building the ML model. In further embodiments, the ML model may comprise one of a multiclass classification model (e.g., a decision tree model which utilizes a decision tree algorithm) and a neural network model to label and classify the resource requirements specified by the user in real-time.

Aspects of the present invention include a method, system, and computer program product for simplifying quota deduction for accelerators based on resource requirements specified by a user. For example, a computer-implemented method includes: receiving user-submitted accelerator resource requirements by a cloud orchestrator; analyzing accelerator resource requirement features to extract dynamic resource claims; classifying user resource requirements for accelerators in different classes by utilizing an ML model; transmitting the classification to a mapping subsystem to generate integer values of the classifications; and utilizing the integer values of the classification to subtract a quota owned by a node in a quota management tree.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as quota representation and management code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

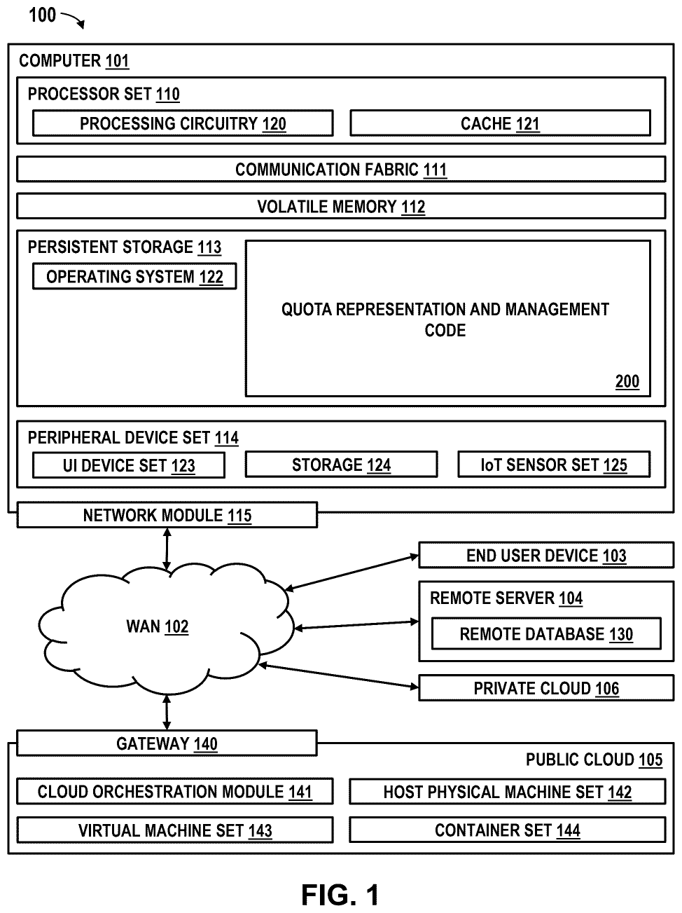

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images. ” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

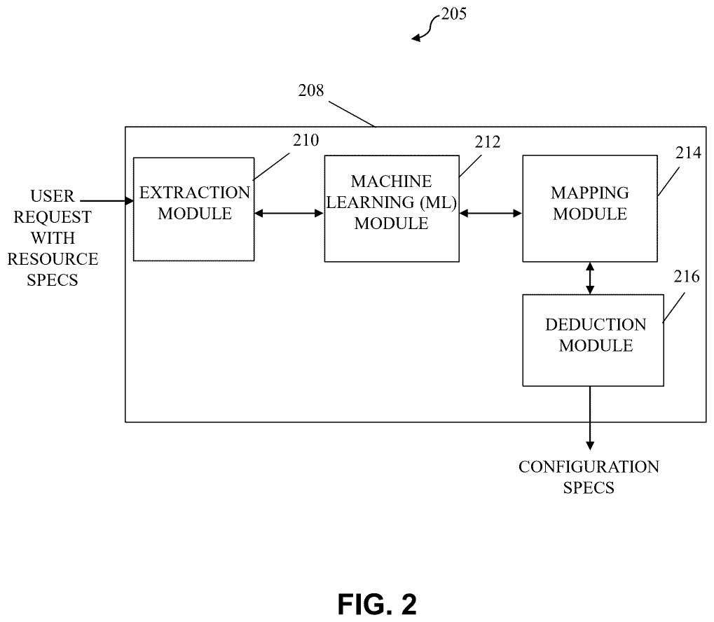

FIG. 2 shows a block diagram of an exemplary environment 205 in accordance with aspects of the present invention. In embodiments, the environment 205 includes a quota representation and management server 208, which may comprise one or more instances of the computer 101 of FIG. 1. In other examples, the quota representation and management server 208 comprises one or more virtual machines or one or more containers running on one or more instances of the computer 101 of FIG. 1.

In embodiments, the quota representation and management server 208 of FIG. 2 comprises an extraction module 210, a machine learning (ML) module 212, a mapping module 214, and a deduction module 216, each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the present invention as described herein. These modules of the code of block 200 are executable by the processing circuitry 120 of FIG. 1 to perform the inventive methods as described herein. The quota representation and management server 208 may include additional or fewer modules than those shown in FIG. 2. In an example, the quota representation and management server 208 comprises a cloud orchestrator such as Kubernetes. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

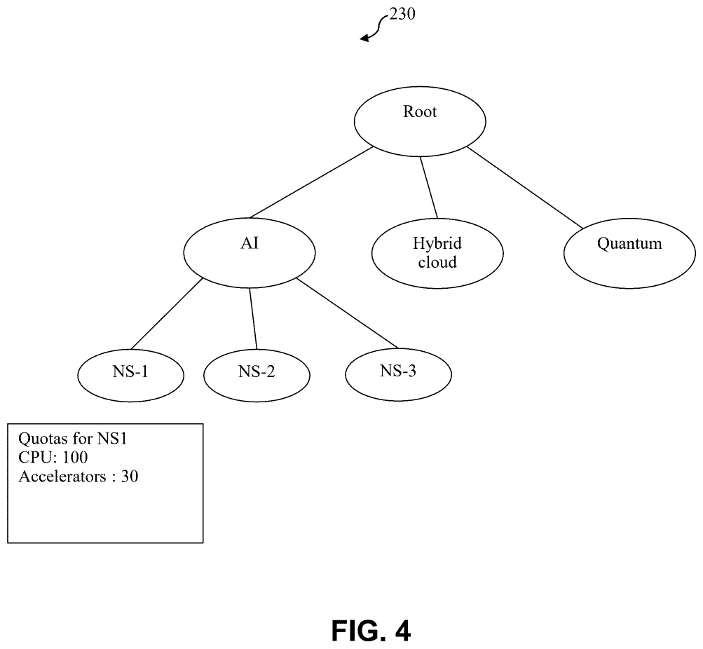

In aspects of the present invention, the quota representation and management server 208 simplifies quota management for administrators. In embodiments, quota management refers to management of computing resources for nodes within a quota management tree (an example of which is described in further detail in FIG. 4). In further aspects of the present invention, the quota representation and management server 208 subtracts a quota for emerging heterogenous devices in a cloud. In embodiments of the present invention, the quota representation and management server 208 generates configuration specifications for accelerators based on at least one user resource specification request. In further embodiments of the present invention, the quota representation and management server 208 executes the accelerators using the generated configuration specifications for AI workloads.

In various examples, the quota representation and management server 208 includes data corresponding with different department teams in an organization. In further embodiments, the quota representation and management server 208 uses different types of GPUs. In one example, the quota representation and management server 208 allows for the different departments teams to observe a single GPU quota for different accelerators, such as A30, V100, H100, etc. In this example, the quota representation and management server 208 is configured to subtract ratioed quotas when a job uses H100 vs V110 in a computing system. Also, the quota representation and management server 208 allows for administrators to include a single quota value into a quota system that is able to cover device heterogeneity and share strategies exposed by hardware devices and priorities.

In accordance with aspects of the present invention, the extraction module 210 receives a user request with resource specifications from an external application on a computing device. In one example, the resource specifications include memory requirements, processing requirements, and priorities for execution of accelerators. In embodiments, the extraction module 210 receives the user request with resource specifications in a lightweight text form such as a yaml ain't markup language (i.e., yaml). In further embodiments, the user request with the resource specifications is utilized for configuring accelerators. In aspects of the present invention, the accelerators comprise a high-performance parallel computation machine that is specifically designed for efficient processing of AI workloads.

In embodiments, the extraction module 210 extracts select resource management sections from the user request with resource specifications. In further embodiments, the extraction module 210 extracts dynamic resource claims such as a central processing unit (CPU) requirement of a job, a GPU type, a GPU memory requirement, a random access memory (RAM) requirement, and a priority. In an example, the extraction module 210 extracts features such as an A100 type, a four count, a multi-instance GPU enabled (i.e., MigEnabled), a MigClaim of mig-3 g·.40 gb, and resource requirements of other dimensions, such as CPU and RAM. The extraction module 210 then sends the extracted select resource management sections to the machine learning (ML) module 212.

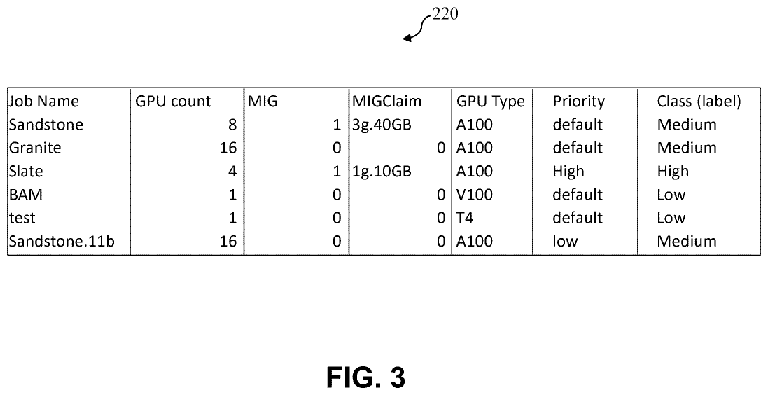

In embodiments, the ML module 212 receives the extracted select resource management sections and classifies the extracted select resource management sections for the accelerators in different classes such as high, medium, and low. However, embodiments are not limited to this example and can include multiple N classes, in which N is an integer value greater than three. In further embodiments, the ML module 212 classifies the extracted select resource management sections for classifying the user accelerator requests. In aspects of the present invention, the ML module 212 utilizes a first ML model which comprises at least one of a multiclass classification model (e.g., a decision tree model which utilizes a decision tree algorithm) and a neural network model to label and classify the user accelerator request. In further embodiments, the ML module 212 receives a historical dataset which includes historical classifications and corresponding historical resource management sections and trains the first ML model based on the historical dataset. In aspects of the present invention, the first ML module 212 classifies the extracted select resource management sections based on the trained first ML model. The ML module 212 further trains the first ML model based on the classified extracted select resource management sections to improve accuracy for future classifications. The ML module 212 sends the classified extracted select resource management sections to the mapping module 214. Further details on the historical dataset are described with regards to FIG. 3.

In accordance with aspects of the present invention, the mapping module 214 receives the classified extracted select resource management sections and maps the classified extracted select resource management sections to integer values corresponding to the classified extracted select resource management sections. In an example, the mapping module 214 uses an integer value of 50 for a “high” classification, an integer value of 25 for a “medium” classification, and an integer value of 10 for a “low” classification. In embodiments, the mapping module 214 performs a database lookup operation to determine integer values which are mapped to the classified extracted select resource management sections. In further embodiments, the mapping module 214 utilizes a second ML model which comprises at least one of the multiclass model (e.g., the decision tree model which utilizes the decision tree algorithm) and the neural network model to determine the integer value based on the classified extracted select resource management sections. In this scenario, the mapping module 214 trains the second ML model based on a historical integer value dataset and corresponding historical resource management sections. In further embodiments, the mapping module 214 determines the integer value based on the trained second ML model. In embodiments, the second ML model of the mapping module 214 is a different model than the first ML model of the ML module 212. In further aspects of the present invention, the mapping module 214 determines the integer values for subtracting a quota owned by a node in a quota management tree. The mapping module 214 sends the integer values to the deduction module 216.

In further embodiments of FIG. 2, the deduction module 216 receives the integer values and deducts (i.e., subtracts) the integer values for the node from the quota management tree to determine configuration specifications for the node. In an example, a total previous quota for a node using an A100 GPU is 30 and an integer value of 10 is received for a low classification. In this situation, the deduction module 216 calculates the configuration specifications of 20 for an A100 GPU which is the result of subtracting the integer value of 10 for the node from the total previous quota of 30. In other words, the configurations specifications are calculated as shown below in Equation 1:

Configuration Specifications=Total Previous Quota for Node −Integer Values for the Node (Equation 1).

In aspects of the present invention in FIG. 2, the deduction module 216 sends the configuration specifications for the node to an external system for optimizing accelerators for AI workloads. For example, the external system may use the configuration specifications to execute the accelerators running AI workloads on the external system. In further embodiments, the deduction module 216 executes the accelerators using the configuration specifications for the AI workloads. In this example, the deduction module 216 executes the A100 GPU with a configuration spec of 20.

In another embodiment of FIG. 2, the mapping module 214 directly maps the extracted selected resource management sections from the extraction module 210 to integer values using a representation table. In this embodiment, the mapping module 214 utilizes the representation table created by a subject matter expert to map the extracted selected resource managements sections directly to the integer values. In this embodiment, the ML module 212 would not classify the extracted selected resource management sections from the extraction module 210. Accordingly, this embodiment would not utilize any ML model to determine the configuration specifications.

FIG. 3 shows an example of a historical dataset 220 in accordance with aspects of the present invention. As described above with reference to FIG. 2, the historical dataset 220 includes historical classifications and corresponding historical resource management sections. In the example of FIG. 3, the historical dataset 220 includes specific data such as a job name, a CPU count, a MIG Enabled Value, a MIGClaim, a GPU type, a priority, and a class (label). In the example of FIG. 3, the class (i.e., label) could be one class value of high, medium, and low. In FIG. 3, the job name “slate” uses less resources and has a high priority, so the historical dataset 220 classifies this job as “high” because the priority is high. Further, the job name “sandstone.11b” uses the entire resources of an A100 and has a low priority, so the historical dataset 220 classifies this job as “medium”. In this scenario, although the resources consumed are high, the priority is low. Thus, the historical dataset 220 classifies the “sandstone.11b” as medium because of the priority.

FIG. 4 shows an example of a quota management tree 230 in accordance with aspects of the present invention. In embodiments, the quota management tree 230 includes a root node, an artificial intelligence (AI) node, a hybrid cloud, a quantum node, and namespace nodes (NS-1, NS-2, NS-3 nodes) under the AI node. In further embodiments, each of the namespace nodes (NS-1, NS-2, and NS-3 nodes) includes accelerators which are executed for AI workloads. For example, the deduction module 216 deducts at least one integer value from a total previous quota for the accelerators within the AI node for the quota management tree 230 to determine configuration specifications. In further aspects of the present invention, the deduction module 216 executes the accelerators including an A100 GPU for AI workloads using the configuration specifications including a CPU count of 100 for namespace node NS-1 under the AI node. In further embodiments, each node (e.g., the root node, the AI node, a hybrid cloud, a quantum node, and namespace nodes NS-1, NS-2, and NS-3) of the quota management tree 230 corresponds with a department in a corporate organization.

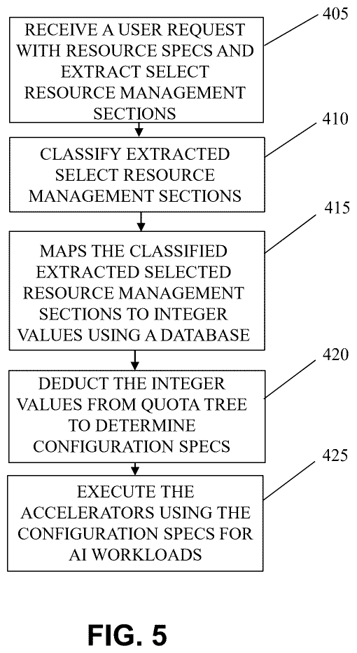

FIG. 5 shows a flowchart of an exemplary method in accordance with aspects of the present invention. Steps of the method may be carried out in the environment of FIG. 2 and are described with reference to elements depicted in FIG. 2.

At step 405, the system receives, at the extraction module 210, a user request with resource specifications from an external application. In embodiments and as described with FIG. 2, the extraction module 210 receives the user request with resource specifications for configuring accelerators and extracts select resource management sections from the user request with resource specifications. At step 410, the system classifies, at the ML module 212, the extracted select resource management sections for the accelerators in different classes. In embodiments and as described with FIG. 2, the ML module 212 utilizes an ML model which comprises at least one of a multiclassification model and a neural network model to label and classify the user accelerator request.

At step 415, the system maps, at the mapping module 214, the classified extracted selected resource management sections to integer values using a database. Also, in embodiments and as described with FIG. 2, the mapping module 214 performs a database lookup operation on the database to determine integer values which are mapped to the classified extracted select resource management sections.

At step 420, the system deducts, at the deduction module 216, the integer values for the node from a quota management tree to determine configuration specifications for the node. In embodiments and as described with FIG. 2, the deduction module 216 determines the configuration specifications for the node by subtracting the integer value for the node from a total previous quota of the quota management tree. At step 425, the system executes, at the deduction module 216, the accelerators using the configuration specifications for AI workloads.

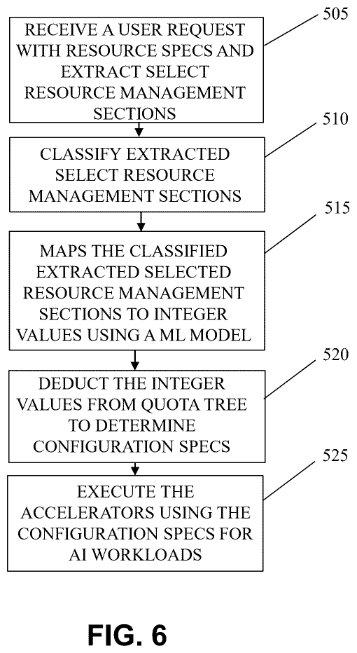

FIG. 6 shows a flowchart of an exemplary method in accordance with aspects of the present invention. Steps of the method may be carried out in the environment of FIG. 2 and are described with reference to elements depicted in FIG. 2.

At step 505, the system receives, at the extraction module 210, a user request with resource specifications from an external application. In embodiments and as described with FIG. 2, the extraction module 210 receives the user request with resource specifications for configuring accelerators and extracts select resource management sections from the user request with resource specifications. At step 510, the system classifies, at the ML module 212, the extracted select resource management sections for the accelerators in different classes. In embodiments and as described with FIG. 2, the ML module 212 utilizes a first ML model which comprises at least one of a multiclassification model and a neural network model to label and classify the user accelerator request.

At step 515, the system maps, at the mapping module 214, the classified extracted selected resource management sections to integer values using the first ML model. Also, in embodiments and as described with FIG. 2, the mapping module 214 utilizes a second ML model to determine integer values which are mapped to the classified extracted select resource management sections.

At step 520, the system deducts, at the deduction module 216, the integer values for the node from a quota management tree to determine configuration specifications for the node. In embodiments and as described with FIG. 2, the deduction module 216 determines the configuration specifications for the node by subtracting the integer value for the node from a total previous quota of the quota management tree. At step 525, the system executes, at the deduction module 216, the accelerators using the configuration specifications for AI workloads.

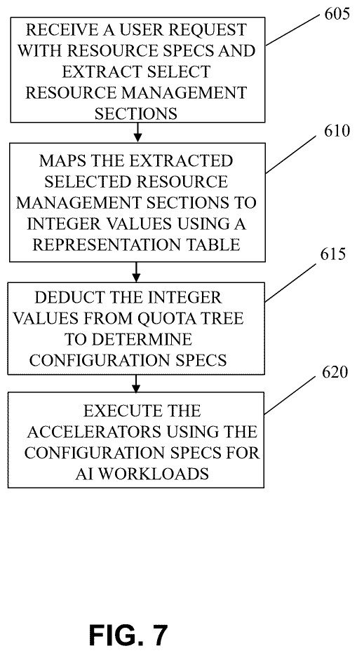

FIG. 7 shows a flowchart of an exemplary method in accordance with aspects of the present invention. Steps of the method may be carried out in the environment of FIG. 2 and are described with reference to elements depicted in FIG. 2.

At step 605, the system receives, at the extraction module 210, a user request with resource specifications from an external application. In embodiments and as described with FIG. 2, the extraction module 210 receives the user request with resource specifications for configuring accelerators and extracts select resource management sections from the user request with resource specifications.

At step 610, the system maps, at the mapping module 214, the extracted selected resource management sections to integer values using a representation table. Also, in embodiments and as described with FIG. 2, the mapping module 214 utilizes the representation table created by a subject matter expert (SME) to map the extracted selected resource management sections to integer value using the representation table.

At step 615, the system deducts, at the deduction module 216, the integer values for the node from a quota management tree to determine configuration specifications for the node. In embodiments and as described with FIG. 2, the deduction module 216 determines the configuration specifications for the node by subtracting the integer value for the node from a total previous quota of the quota management tree. At step 620, the system executes, at the deduction module 216, the accelerators using the configuration specifications for AI workloads.

In embodiments, a service provider could offer to perform the processes described herein. In this case, the service provider can create, maintain, deploy, support, etc., the computer infrastructure that performs the process steps of the present invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the present invention provides a computer-implemented method, via a network. In this case, a computer infrastructure, such as computer 101 of FIG. 1, can be provided and one or more systems for performing the processes of the present invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the present invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, by a processor set, a user request with resource specifications from an external application;
extracting, by the processor set, select resource management sections from the received user request;
classifying, by the processor set, the extracted select resource management sections using a first machine learning (ML) model which is trained using a historical dataset;
mapping, by the processor set, the classified extracted select resource management sections to at least one integer value;
deducting, by the processor set, the at least one integer value from a quota management tree to determine configuration specifications; and
executing, by the processor set, accelerators using the configuration specifications for artificial intelligence (AI) workloads.

2. The computer-implemented method of claim 1, wherein the resource management sections comprise a graphical processing unit (GPU) type, a central processing unit (CPU) memory requirement, and a random access memory (RAM) requirement.

3. The computer-implemented method of claim 1, wherein the classified extracted select resource management sections comprises a class of a plurality of classes.

4. The computer-implemented method of claim 3, wherein the plurality of classes comprises a high class, a medium class, and a low class.

5. The computer-implemented method of claim 3, wherein the at least one integer value corresponds with the class of the plurality of classes.

6. The computer-implemented method of claim 1, wherein the mapping the classified extracted select resource management to the at least one integer value is performed using a database lookup operation of a database.

7. The computer-implemented method of claim 1, wherein the mapping the classified extracted select resource management to the at least one integer value is performed by utilizing a second ML model which is trained using a historical integer value dataset.

8. The computer-implemented method of claim 1, wherein the first ML model comprises a decision tree model which utilizes a decision tree algorithm to classify the extracted select resource management sections.

9. The computer-implemented method of claim 1, wherein the first ML model comprises a neural network model to classify the extracted select resource management sections.

10. The computer-implemented method of claim 1, wherein the accelerators comprise at least one graphical processing unit (GPU).

11. The computer-implemented method of claim 1, wherein the accelerators comprise at least one field programmable gate array (FPGA).

12. A computer program product comprising one or more computer readable storage media having program instructions collectively stored on the one or more computer readable storage media, the program instructions executable to:
receive a user request with resource specifications from an external application;
extract select resource management sections from the received user request;
classify the extracted select resource management sections using a first machine learning (ML) model which is trained using a historical classification dataset;
map the classified extracted select resource management sections to at least one integer value by using a second ML model which is trained using a historical integer value dataset;
deduct the at least one integer value from a quota management tree to determine configuration specifications; and
execute accelerators using the configuration specifications for artificial intelligence (AI) workloads.

13. The computer program product of claim 12, wherein the resource management sections comprise a graphical processing unit (GPU) type, a central processing unit (CPU) memory requirement, and a random access memory (RAM) requirement.

14. The computer program product of claim 12, wherein the classified extracted select resource management sections comprises a class of a plurality of classes.

15. The computer program product of claim 14, wherein the plurality of classes comprises a high class, a medium class, and a low class.

16. The computer program product of claim 14, wherein the at least one integer value corresponds with the class of the plurality of classes.

17. The computer program product of claim 12, wherein the first ML model comprises a decision tree model which utilizes a decision tree algorithm to classify the extracted select resource management sections.

18. The computer program product of claim 12, wherein the first ML model comprises a neural network model to classify the extracted select resource management sections.

19. The computer program product of claim 12, wherein the accelerators comprise at least one graphical processing unit (GPU).

20. A system comprising:
a processor set, one or more computer readable storage media, and program instructions collectively stored on the one or more computer readable storage media, the program instructions executable to:
receive a user request with resource specifications from an external application;
extract select resource management sections from the received user request;
classify the extracted select resource management sections using a first machine learning (ML) model which is trained using a historical classification dataset;
map the classified extracted select resource management sections to at least one integer value by using a second ML model which is trained using a historical integer value dataset;
deduct the at least one integer value from a quota management tree to determine configuration specifications; and
execute accelerators using the configuration specifications for artificial intelligence (AI) workloads,
wherein the first ML model comprises a decision tree model which utilizes a decision tree algorithm to classify the extracted select resource management sections.
